(19) United States
(12) Patent Application Publication
(10) Pub. No.: US 2026/0251168 A1
(43) Pub. Date: Aug. 27, 2026

(54) Connector And Bed Frame

(71) Applicant: Shenzhen Baitu Network Co., Ltd, Shenzhen (CN)

(72) Inventor: Lixuan Li, Fuzhou (CN)

(73) Assignee: Shenzhen Baitu Network Co., Ltd, Shenzhen (CN)

(21) Appl. No.: 19/424,230

(22) Filed: Dec. 18, 2025

(30) Foreign Application Priority Data
Feb. 24, 2025 (CN) 202520295420.0

(51) Int. Cl. F16B 12/54; A47C 19/02

(52) U.S. Cl. CPC F16B 12/54; A47C 19/024; A47C 19/025

(57) ABSTRACT

The present disclosure relates to a connector and a bed frame. The connector includes an insertion body and a buffer body, where an insertion groove is formed in the insertion body, and the insertion groove matches an end portion of the second rod member and is configured to receive the second rod member; and the buffer body is disposed at a lower end of the insertion body and configured to buffer a pressure applied by the second rod member to the insertion body. A mounting method for a first rod member and a second rod member of a bed slat frame is simple, quick, and labor-saving, and it is convenient for a user to assemble the bed slat frame independently. Moreover, during use, the connector provides a buffering effect on a force applied to the first rod member, which is beneficial for extending the service life of the connector.

### TECHNICAL FIELD

The present disclosure relates to the field of bed products, and in particular to a connector and a bed frame.

### BACKGROUND

A bed frame in the prior art generally includes a bed slat frame for supporting a mattress, where the bed slat frame includes a frame (which is formed by enclosing of a plurality of first rod members) and a plurality of second rod members arranged in the frame at intervals, the first rod members are connected to the second rod members, and the first rod members and the second rod members are connected though diverse methods, such as bolt fastening connection, riveting, and welding. However, the above connection methods are cumbersome and insufficiently convenient.

### SUMMARY

In the embodiments of the present disclosure, there are provided a connector and a bed frame. A mounting method for a first rod member and a second rod member of a bed slat frame is simple, quick, and labor-saving, and it is convenient for a user to assemble the bed slat frame independently. Moreover, during use, the connector provides a buffering effect on a force applied to the first rod member, which is beneficial for extending the service life of the connector.

A connector is configured to connect a first rod member and a second rod member, and mounted on the first rod member, where the connector includes:

an insertion body, where an insertion groove is formed in the insertion body, and the insertion groove matches an end portion of the second rod member and is configured to receive the second rod member; and

a buffer body, where the buffer body is disposed at a lower end of the insertion body and configured to buffer a pressure applied by the second rod member to the insertion body.

In an embodiment, the insertion body includes a bottom plate, a left side plate, a right side plate, and a rear side plate, where the left side plate, the right side plate, and the rear side plate are disposed on the bottom plate, the left side plate is connected to the right side plate through the rear side plate, and the left side plate and the right side plate are arranged opposite to each other; and the bottom plate, the left side plate, the right side plate, and the rear side plate enclose a space to form the insertion groove.

In an embodiment, the buffer body is disposed at the lower end of the insertion body, and the buffer body includes a first buffer portion and a second buffer portion, where both the first buffer portion and the second buffer portion are connected to a surface of the bottom plate facing away from the rear side plate; the first buffer portion includes a first end and a second end arranged opposite to each other, the second buffer portion includes a third end and a fourth end arranged opposite to each other, the first end and the third end are both connected to the bottom plate, and the second end and the fourth end are free ends; a distance from the first end to the third end is a, and a distance from the second end to the fourth end is b, where a < b; and an angle α is formed between the first buffer portion and the second buffer portion, where 1° ≤ α ≤ 15°.

In an embodiment, the connector further includes a limiting block, where the limiting block is disposed on an outer wall of the insertion body; and the connector is mounted in an accommodating groove of the first rod member, a limiting groove corresponding to the limiting block is formed in a wall of the accommodating groove, and the limiting block and the limiting groove cooperate to restrict the connector in the accommodating groove.

In an embodiment, an opening dimension of the accommodating groove is c; when the first buffer portion and the second buffer portion are in an unstressed state, b > c; and when the first buffer portion and the second buffer portion are under an external force and in a close contact state, b < c.

In an embodiment, outer side walls of the left side plate and the right side plate away from the rear side plate each have a first rib protruding outward, and the first rib is parallel to the rear side plate; top portions of the left side plate, the right side plate, and the rear side plate each have a second rib protruding outward, and the second rib is parallel to the bottom plate; a side wall of the bottom plate away from the rear side plate has a third rib protruding downward, and the third rib is parallel to the rear side plate; the third rib, the first rib, and the second rib are sequentially connected end to end; and the third rib, the first rib, and the second rib are configured to contact an outer surface of the first rod member.

In an embodiment, a bed frame includes:

a bed slat frame, where the bed slat frame includes a first rod member and a second rod member, and an accommodating groove is formed in the first rod member; and

a connector, where the connector is accommodated in the accommodating groove, and the second rod member is connected to the first rod member through the connector; and the connector includes an insertion body and a buffer body, where an insertion groove is formed in the insertion body, and the insertion groove matches an end portion of the second rod member and is configured to receive the second rod member; and the buffer body is disposed at a lower end of the insertion body and configured to buffer a pressure applied by the second rod member to the insertion body.

In an embodiment, the bed frame further includes a support leg, where the support leg is connected to the bed slat frame and configured to support the bed slat frame, a plurality of first screw holes are formed in the support leg along a height direction thereof, a second screw hole is formed in a side portion of the bed slat frame, and the second screw hole is threadedly connected to one of the first screw holes through a screw.

In an embodiment, the bed slat frame further includes a U-shaped connecting bracket, the first rod member includes a first side rod and a second side rod, the U-shaped connecting bracket includes two opposite ends, and the two ends of the U-shaped connecting bracket are hinged to the first side rod and the second side rod, respectively, and configured to allow the first side rod and the second side rod to rotate relative to each other.

In an embodiment, the bed slat frame includes a baffle plate, where the baffle plate is mounted on the first rod member.

In the connector provided in the present disclosure, the connector includes the insertion body and the buffer body, where the insertion body is mounted in the first rod member, the insertion groove is formed in the insertion body, and the insertion groove matches the end portion of the second rod member and is configured to receive the second rod member, such that connection of the second rod member to the first rod member is achieved. This connection method is simple and quick, which is beneficial for improving mounting efficiency. The buffer body is disposed at the lower end of the insertion body. When the second rod member is subjected to an external force and thereby applies a force to the connector, the buffer body deforms to buffer the pressure applied by the second rod member to the insertion body, which is beneficial for extending the service life of the connector.

In the bed frame provided in the present disclosure, each component may be split and packaged separately to facilitate transportation. Use of the connector to connect the first rod member and the second rod member facilitates rapid assembly of the bed slat frame and improves mounting efficiency.

The bed frame provided in the present disclosure further allows flexible adjustment of a height of the support leg as needed. As the plurality of first screw holes are formed in the support leg, and the second screw hole is formed in the side portion of the bed slat frame, a user may select an appropriate first screw hole at a desired height and securely connect the first screw hole to the second screw hole, such that the purpose of adjusting the height of the support leg is achieved.

The above summary is provided for illustrative purposes only and is not intended to be limiting in any manner. In addition to the illustrative aspects, embodiments, and features described above, further aspects, embodiments, and features of the present disclosure will be readily understood with reference to the drawings and the following detailed description.

### BRIEF DESCRIPTION OF THE DRAWINGS

In the drawings, unless otherwise specified, the same reference numerals throughout a plurality of drawings denote the same or similar components or elements. The drawings are not necessarily drawn to scale. It should be understood that the drawings merely depict some embodiments disclosed in the present disclosure and should not be considered as limiting the scope of the present disclosure.

FIG. 1 is a schematic perspective structural view of a connector provided in an embodiment of the present disclosure.

FIG. 2 is a schematic perspective structural view of a connector provided in an embodiment of the present disclosure.

FIG. 3 is a schematic structural view of a connector provided in an embodiment of the present disclosure from another perspective.

FIG. 4 is a schematic perspective structural view of a bed frame provided in an embodiment of the present disclosure.

FIG. 5 is a schematic enlarged view of a portion A of the bed frame shown in FIG. 4.

FIG. 6 is a schematic enlarged view of a portion B of the bed frame shown in FIG. 4.

FIG. 7 is a schematic enlarged view of a portion D of the bed frame shown in FIG. 4.

FIG. 8 is a schematic perspective structural view of a bed frame provided in an embodiment of the present disclosure.

FIG. 9 is a schematic perspective structural view of the bed frame shown in FIG. 8 from another perspective.

### Reference numerals in the figures

1-connector; 11-insertion body; 111-insertion groove; 112-bottom plate; 113-left side plate; 114-right side plate; 115-rear side plate; 12-buffer body; 121-first buffer portion; 121a-first end; 121b-second end; 122-second buffer portion; 122a-third end; 122b-fourth end; 13-limiting block; 14-first rib; 15-second rib; 16-third rib; 2-bed slat frame; 21-first rod member; 213-accommodating groove; 213a-limiting groove; 211-first side rod; 212-second side rod; 214-outer surface; 22-second rod member; 23-support leg; 231-first screw hole; 232-elongated plate member; 24-second screw hole; 25-screw; 26-U-shaped connecting bracket; 27-baffle plate; and 3-headboard.

### DETAILED DESCRIPTION

Various implementations or embodiments implementing the technical solutions of the subject matter are disclosed below. To simplify the disclosure, specific examples of elements and arrangements are described below. These are, of course, merely examples and are not intended to limit the protection scope of the present disclosure. For example, in the specification, a first feature being formed above or on a second feature may include an implementation in which the first and second features are formed in direct contact, and may also include an implementation in which additional features are formed between the first and second features, such that the first and second features may not be in direct contact. Additionally, reference numerals and/or letters may be repeated in different examples in this disclosure. Such repetition is for brevity and clarity and does not in itself indicate any relationship between the discussed implementations and/or structures. Further, when a first element is described as being connected to or combined with a second element, such description includes an implementation in which the first and second elements are directly connected or combined with each other, as well as an implementation in which one or more intervening elements are included to indirectly connect or combine the first and second elements.

In the following, only certain exemplary embodiments are briefly described. As those skilled in the art will recognize, the described embodiments may be modified in various ways without departing from the spirit or scope of the present disclosure. Therefore, the drawings and descriptions are regarded as illustrative in nature and not restrictive.

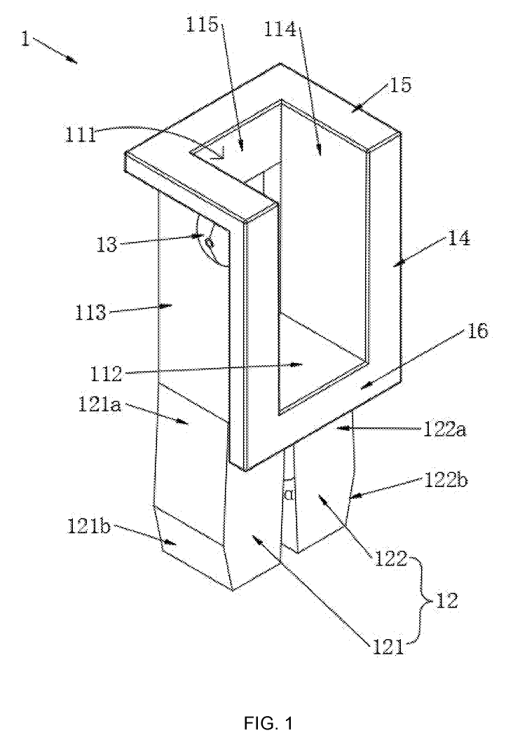

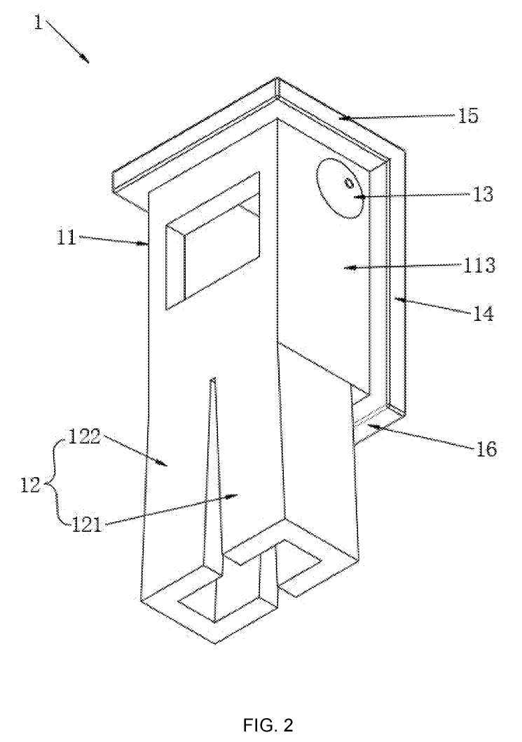

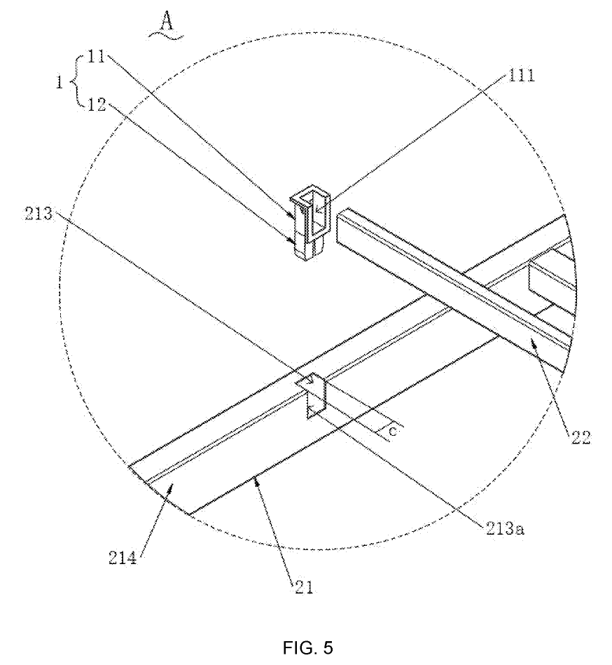

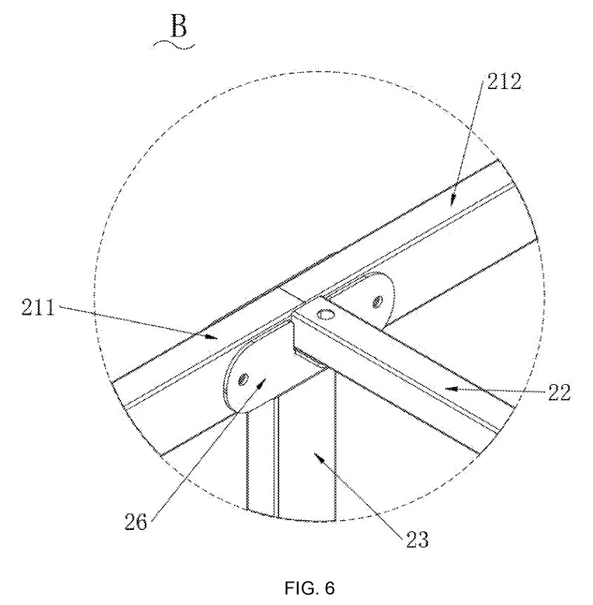

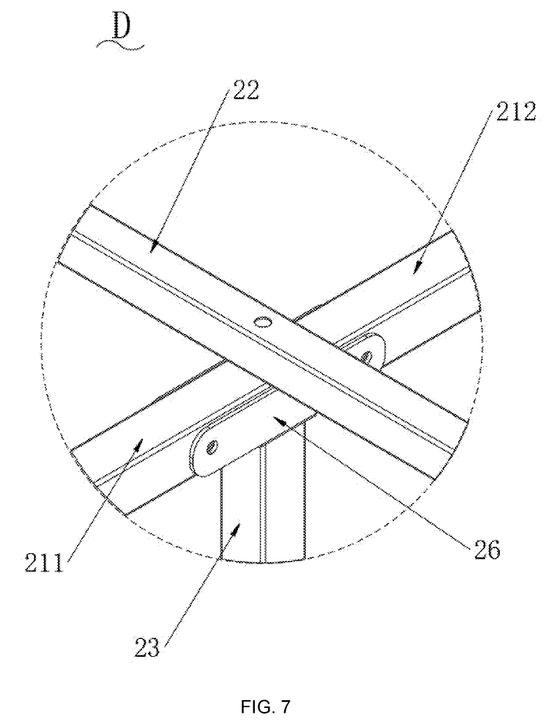

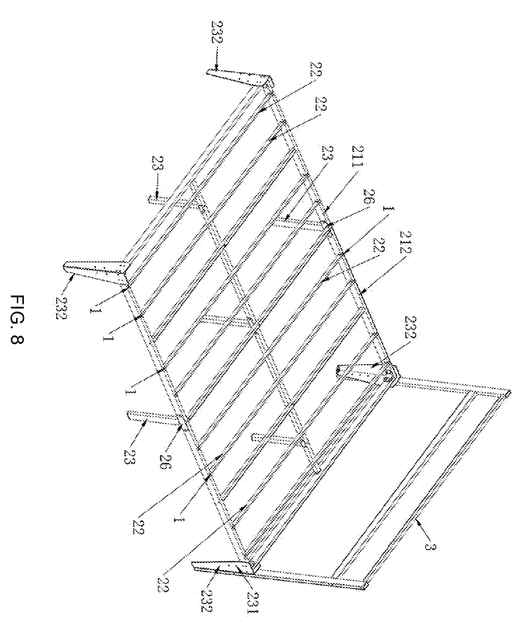

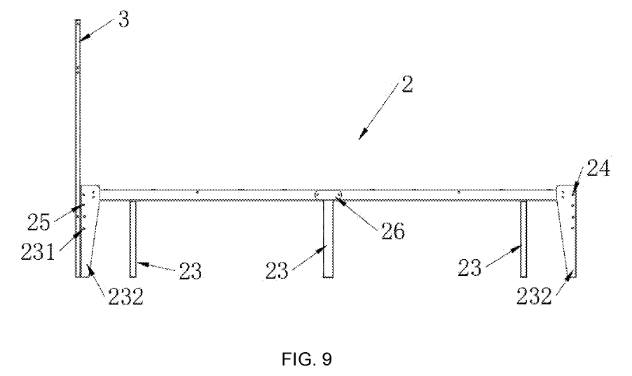

With reference to FIGS. 1 to 9, the present disclosure provides a connector 1 configured to connect a first rod member 21 and a second rod member 22. An accommodating groove 213 is formed in the first rod member 21, and the accommodating groove 213 is configured to accommodate the connector 1. The connector 1 includes an insertion body 11 and a buffer body 12, where an insertion groove 111 is formed in the insertion body 11, and the insertion groove 111 matches an end portion of the second rod member 22 and is configured to receive the second rod member 22. The buffer body 12 is disposed at a lower end of the insertion body 11 and configured to buffer a pressure applied by the second rod member 22 to the insertion body 11. In the connector 1 provided in the present disclosure, the insertion groove 111 matches the end portion of the second rod member 22 and is configured to receive the second rod member 22, such that connection of the second rod member 22 to the first rod member 21 is achieved. This connection method is simple and quick, which is beneficial for improving mounting efficiency. The buffer body 12 is disposed at the lower end of the insertion body 11. When the second rod member 22 is subjected to an external force and thereby applies a force to the connector 1, the buffer body 12 deforms to buffer the pressure applied by the second rod member 22 to the insertion body 11, which is beneficial for extending the service life of the connector 1.

With reference to FIGS. 1 to 4, the insertion body 11 includes a bottom plate 112, a left side plate 113, a right side plate 114, and a rear side plate 115, where the left side plate 113, the right side plate 114, and the rear side plate 115 are disposed on the bottom plate 112, the left side plate 113 is connected to the right side plate 114 through the rear side plate 115, and the left side plate 113 and the right side plate 114 are arranged opposite to each other; and the bottom plate 112, the left side plate 113, the right side plate 114, and the rear side plate 115 enclose a space to form the insertion groove 111. In some embodiments, the insertion body 11 is a plastic part or metal part.

With reference to FIGS. 1 to 4, in an embodiment, the buffer body 12 is disposed at the lower end of the insertion body 11, and the buffer body 12 includes a first buffer portion 121 and a second buffer portion 122, where both the first buffer portion 121 and the second buffer portion 122 are connected to the bottom plate 112; and the first buffer portion 121 includes a first end 121a and a second end 121b arranged opposite to each other, the second buffer portion 122 includes a third end 122a and a fourth end 122b arranged opposite to each other, the first end 121a and the third end 122a are both connected to the bottom plate 112, and the second end 121b and the fourth end 122b are free ends. A distance from the first end 121a to the third end 122a is a, and a distance from the second end 121b to the fourth end 122b is b, where a < b; and an angle α is formed between the first buffer portion 121 and the second buffer portion 122, where 1° ≤ α ≤ 15°. α may be 1°, 5°, 10°, 15°, or other values. The angle formed between the first buffer portion 121 and the second buffer portion 122 provides a space of deformation for the first buffer portion 121 and the second buffer portion 122, which is beneficial for buffering a pressure applied to the connector 1 when the connector 1 is subjected to an external force. Specifically, the first buffer portion 121 and the second buffer portion 122 are plastic parts, and the first buffer portion 121, the second buffer portion 122, and the insertion body 11 are each formed in an integral structure.

Further, the insertion body 11 and the buffer body 12 of the connector 1 are formed as an integral structure directly through a single forming process (such as casting, injection molding, or 3D printing). Additionally, the insertion body 11 and the buffer body 12 of the connector 1 may also be combined through a subsequent processing method such as welding or bolting. For example, in some embodiments, the buffer body 12 is a compression spring, a silicone elastomer, or the like, which is not specifically limited herein.

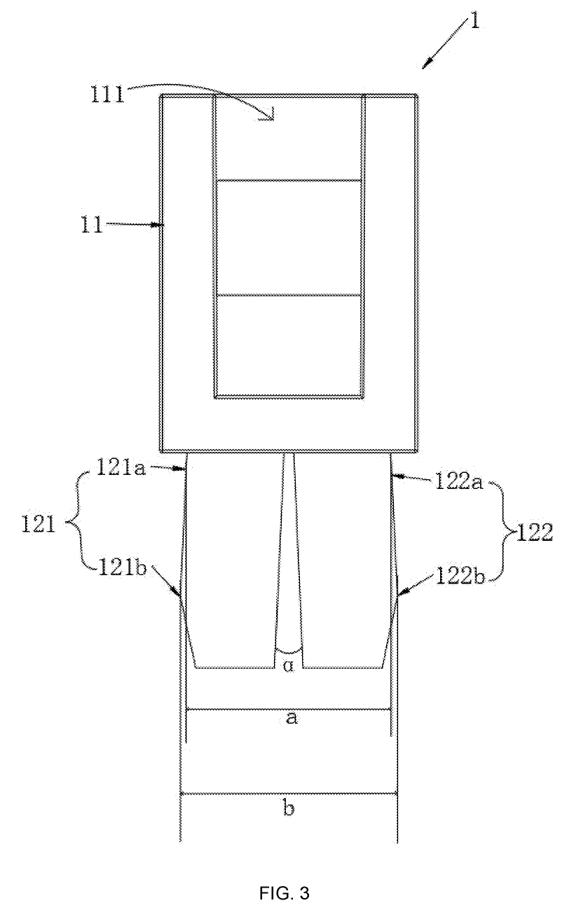

With reference to FIGS. 3 to 5, in an embodiment, an opening dimension of the accommodating groove 213 is c; when the first buffer portion 121 and the second buffer portion 122 are in an unstressed state, b > c; and when the first buffer portion 121 and the second buffer portion 122 are under an external force and in a close contact state, b < c. Specifically, by squeezing the first buffer portion 121 and the second buffer portion 122, the angle α between the first buffer portion 121 and the second buffer portion 122 changes, such that the distance b between the second end 121b and the fourth end 122b is changed. For example, when the first buffer portion 121 and the second buffer portion 122 are squeezed to force the second end 121b of the first buffer portion 121 and the fourth end 122b of the second buffer portion 122 to contact and fit together, the distance b between the second end 121b and the fourth end 122b is less than the opening dimension c of the accommodating groove 213. At the moment, the connector 1 may be placed into the accommodating groove 213. After the connector 1 is placed into the accommodating groove 213, the buffer body is no longer subjected to an external force, and b > c, such that the connector 1 is restricted in the accommodating groove 213. Thus, to facilitate transportation and part storage, the connector 1 may be placed into the accommodating groove 213 in the first rod member 21 in advance, and the connector 1 is restricted in the accommodating groove 213 and will not fall out, thereby eliminating concerns about losing the connector 1 during transportation and also saving packaging costs. Further, after the second rod member 22 is mounted into the accommodating groove 213 of the first rod member 21, the second rod member 22 applies a pressure to the connector 1 under an external force, and the angle α between the first buffer portion 121 and the second buffer portion 122 of the buffer body 12 is increased and serves to buffer the pressure applied by the second rod member 22 to the insertion body 11, which is beneficial for extending the service life of the connector 1.

Further, the second end 121b and the fourth end 122b are configured with inwardly inclined surfaces, which are different from shapes and angles of the first end 121a and the third end 122a. This design of the inwardly inclined surfaces may apply to an accommodating groove 213 with a smaller dimension c, such that the applicability of the connector 1 is improved, and an installer may perform insertion more quickly during operation.

With reference to FIGS. 1 to 3 and FIG. 5, in an embodiment, the connector 1 further includes a limiting block 13, where the limiting block 13 is disposed on an outer wall of the insertion body 11; a limiting groove 213a corresponding to the limiting block 13 is formed in a wall of the accommodating groove 213, and the limiting block 13 and the limiting groove 213a cooperate to restrict the connector 1 in the accommodating groove 213. Specifically, the limiting block 13 is a circular protrusion. When the connector 1 is placed into the accommodating groove 213, the circular protrusion is snapped into the limiting groove 213a, to prevent the connector 1 from being pulled out of the accommodating groove 213. The limiting block 13 may be disposed on the left side plate 113 and the right side plate 114, respectively. In other embodiments, the limiting block 13 may also be disposed on the rear side plate 115.

With reference to FIGS. 1 to 3, in an embodiment, outer side walls of the left side plate 113 and the right side plate 114 away from the rear side plate 115 each have a first rib 14 protruding outward, and the first rib 14 is parallel to the rear side plate 115; top portions of the left side plate 113, the right side plate 114, and the rear side plate 115 each have a second rib 15 protruding outward, the second rib 15 is parallel to the bottom plate 112; a side wall of the bottom plate 112 away from the rear side plate 115 has a third rib 16 protruding downward, and the third rib 16 is parallel to the rear side plate 115; and the third rib 16, the first rib 14, and the second rib 15 are sequentially connected end to end. The third rib 16, the first rib 14, and the second rib 15 are configured to contact an outer surface 214 of the first rod member 21, so as to play a role in restricting the insertion body 11 in the accommodating groove 213.

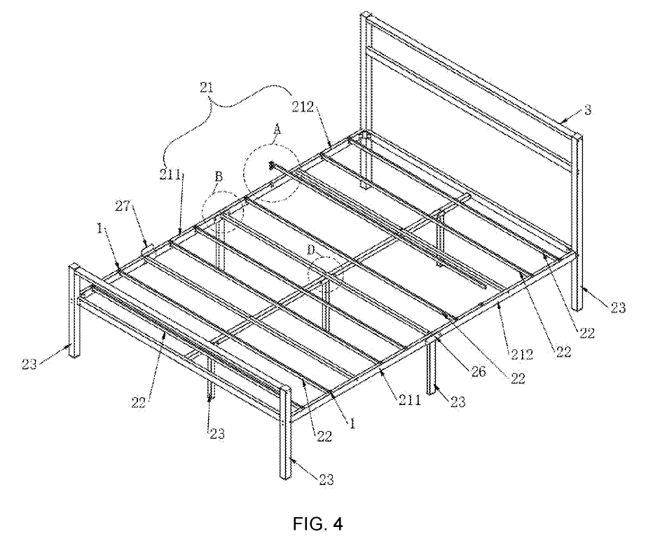

With reference to FIGS. 4 to 8, in an embodiment, a bed frame includes a bed slat frame 2 and a connector 1, where the bed slat frame 2 includes a first rod member 21 and a second rod member 22, and an accommodating groove 213 is formed in a side surface of the first rod member 21.

The connector 1 is accommodated in the accommodating groove 213, and the second rod member 22 is connected to the first rod member 21 through the connector 1; and the connector 1 includes an insertion body 11 and a buffer body 12, where an insertion groove 111 is formed in the insertion body 11, and the insertion groove 111 matches an end portion of the second rod member 22 and is configured to receive the second rod member 22; and the buffer body 12 is disposed at a lower end of the insertion body 11 and configured to buffer a pressure applied by the second rod member 22 to the insertion body 11. In some embodiments, there are two first rod members 21, which are arranged parallel and spaced apart, and a plurality of second rod members 22 are disposed and mounted between the two first rod members 21. Specifically, both ends of each of the second rod members 22 are mounted onto the two first rod members 21 through the connectors 1, respectively, and the plurality of second rod members 22 are arranged parallel and spaced apart, such that the bed slat frame 2 is formed.

With reference to FIGS. 4 to 9, in an embodiment, the bed frame further includes a support leg 23, where the support leg 23 is connected to the bed slat frame 2 and configured to support the bed slat frame 2, a plurality of first screw holes 231 are formed in the support leg 23 along a height direction thereof, a second screw hole 24 is formed in a side portion of the bed slat frame 2, and the second screw hole 24 is threadedly connected to one of the first screw holes 231 through a screw 25. A user may flexibly adjust a height of the support leg 23 as needed. As the plurality of first screw holes 231 are formed in the support leg 23, and the second screw hole 24 is formed in the side portion of the bed slat frame 2, the user may select an appropriate first screw hole 231 at a desired height and securely connect the first screw hole 231 to the second screw hole 24, such that the purpose of adjusting the height of the support leg 23 is achieved. In some embodiments, the support leg 23 is an elongated plate member 232 with an L-shaped cross-section, the bed slat frame 2 is a rectangular bed slat frame 2, the plurality of first screw holes 231 are formed in the elongated plate member 232 along a length direction thereof, and the elongated plate members 232 are mounted onto four corners of the rectangular bed slat frame 2 through screws 25 in a one-to-one correspondence, respectively.

With reference to FIGS. 4 to 9, in an embodiment, the bed slat frame 2 further includes a U-shaped connecting bracket 26, the first rod member 21 includes a first side rod 211 and a second side rod 212, the U-shaped connecting bracket 26 includes two opposite ends, and the two ends of the U-shaped connecting bracket 26 are hinged to the first side rod 211 and the second side rod 212, respectively, and configured to allow the first side rod 211 and the second side rod 212 to rotate relative to each other. Thus, by folding the first side rod 211 and the second side rod 212 toward each other, a volume of the bed slat frame 2 is reduced, thereby facilitating packaging and transportation, and saving a space during storage. In some embodiments, to further enhance the stability and load-bearing capacity of the bed slat frame 2, a support leg 23 is mounted below the U-shaped connecting bracket 26 to provide an additional support force to the bed slat frame 2.

With reference to FIGS. 4, 8, and 9, in an embodiment, the bed frame further includes a headboard 3, where the headboard 3 is disposed above the bed slat frame 2. In some embodiments, the headboard 3 is connected to the support legs 23 through rod members. Specifically, the rod members of the headboard 3 may cooperate with the screw holes in the support legs 23 to adjust a height of the headboard 3. When a baseboard is disposed on a wall of a room of a user, the headboard 3 is raised until a bottom portion of the headboard 3 maintains a certain height above the floor, which accommodates the baseboard. This mounting approach allows the headboard to fit more closely to the wall and reduces shaking.

With reference to FIGS. 4 and 3, in an embodiment, the bed slat frame 2 includes a baffle plate 27, where the baffle plate 27 is mounted on the first rod member 21. Specifically, a shape of the baffle plate 27 matches a shape of the first rod member 21, and is configured to be snapped onto the first rod member 21. After a mattress is placed on the bed slat frame 2, mounting the baffle plate 27 on the first rod member 21 may effectively prevent the mattress from sliding and confine the mattress on the bed slat frame 2.

The advantages or beneficial effects of the above technical solutions include:

In the connector 1 provided in the present disclosure, the connector 1 includes the insertion body 11 and the buffer body 12, where the insertion body 11 is mounted in the first rod member 21, and the insertion groove 111 is formed in the insertion body 11, and the insertion groove 111 matches the end portion of the second rod member 22 and is configured to receive the second rod member 22, such that connection of the second rod member 22 to the first rod member 21 is achieved. This connection method is simple and quick, which is beneficial for improving mounting efficiency. The buffer body 12 is disposed at the lower end of the insertion body 11. When the second rod member 22 is subjected to an external force and thereby applies a force to the connector 1, the buffer body 12 deforms to buffer the pressure applied by the second rod member 22 to the insertion body 11, which is beneficial for extending the service life of the connector 1. Moreover, the structural design of the connector 1 ensures that the connector 1 remains stably inserted into the first rod member 21 during transportation of the bed frame, such that the connector 1 is less prone to detachment.

In the bed frame provided in the present disclosure, each component may be split and packaged separately to facilitate transportation. Use of the connector 1 to connect the first rod member 21 and the second rod member 22 facilitates rapid assembly of the bed slat frame 2 and improves mounting efficiency.

The bed frame provided in the present disclosure further allows flexible adjustment of a height of the support leg 23 as needed. As the plurality of first screw holes 231 are formed in the support leg 23, and the second screw hole 24 is formed in a side portion of the bed slat frame 2, a user may select an appropriate first screw hole 231 at a desired height and securely connect the first screw hole 231 to the second screw hole 24, such that the purpose of adjusting the height of the support leg 23 is achieved.

In the description of the specification, the description of the term “one embodiment”, “some embodiments”, “an example”, “a specific example”, or “some examples” means that specific features, structures, materials, or characteristics described in the embodiment or example are included in at least one embodiment or example of the present disclosure. Moreover, the specific features, structures, materials or characteristics described may be combined in a suitable manner in any one or more embodiments or examples. Additionally, those skilled in the art may combine and integrate different embodiments or examples described in the specification, as well as features thereof, provided such combinations and integrations are not mutually contradictory.

Additionally, terms "first", "second", and the like are for descriptive purposes only and are not to be construed as indicating or implying relative importance or implicitly specifying the quantity of the indicated technical features. Thus, features defined by "first" or "second" may explicitly or implicitly include at least one of such features. In the description of the present disclosure, the term “a plurality of” refers to two or more, unless otherwise specifically defined.

The above descriptions are only specific embodiments of the present disclosure, but the protection scope of the present disclosure is not limited thereto. Various alterations or substitutions of such embodiments readily conceivable by those skilled in the art within the technical scope disclosed herein should fall within the protection scope of the present disclosure. Therefore, the protection scope of the present disclosure is subject to the protection scope of the claims.

What is claimed is:

1. A connector configured to connect a first rod member and a second rod member, and mounted on the first rod member, wherein the connector comprises:
an insertion body, wherein an insertion groove is formed in the insertion body, and the insertion groove matches an end portion of the second rod member and is configured to receive the second rod member; and
a buffer body, wherein the buffer body is disposed at a lower end of the insertion body and configured to buffer a pressure applied by the second rod member to the insertion body.

2. The connector according to claim 1, wherein the insertion body comprises a bottom plate, a left side plate, a right side plate, and a rear side plate, wherein the left side plate, the right side plate, and the rear side plate are disposed on the bottom plate, the left side plate is connected to the right side plate through the rear side plate, and the left side plate and the right side plate are arranged opposite to each other; and the bottom plate, the left side plate, the right side plate, and the rear side plate enclose a space to form the insertion groove.

3. The connector according to claim 2, wherein the buffer body is disposed on an exterior of the insertion body, and the buffer body comprises a first buffer portion and a second buffer portion, wherein both the first buffer portion and the second buffer portion are connected to a surface of the bottom plate facing away from the rear side plate; the first buffer portion comprises a first end and a second end arranged opposite to each other, the second buffer portion comprises a third end and a fourth end arranged opposite to each other, the first end and the third end are both connected to the bottom plate, and the second end and the fourth end are free ends; a distance from the first end to the third end is a, and a distance from the second end to the fourth end is b, wherein a < b; and an angle α is formed between the first buffer portion and the second buffer portion, wherein 1° ≤ α ≤ 15°.

4. The connector according to claim 2, further comprising a limiting block, wherein the limiting block is disposed on an outer wall of the insertion body; and the connector is mounted in an accommodating groove of the first rod member, a limiting groove corresponding to the limiting block is formed in a wall of the accommodating groove, and the limiting block and the limiting groove cooperate to restrict the connector in the accommodating groove.

5. The connector according to claim 4, wherein an opening dimension of the accommodating groove is c; when the first buffer portion and the second buffer portion are in an unstressed state, b > c; and when the first buffer portion and the second buffer portion are under an external force and in a close contact state, b < c.

6. The connector according to claim 2, wherein outer side walls of the left side plate and the right side plate away from the rear side plate each have a first rib protruding outward, and the first rib is parallel to the rear side plate; top portions of the left side plate, the right side plate, and the rear side plate each have a second rib protruding outward, and the second rib is parallel to the bottom plate; a side wall of the bottom plate away from the rear side plate has a third rib protruding downward, and the third rib is parallel to the rear side plate; the third rib, the first rib, and the second rib are sequentially connected end to end; and the third rib, the first rib, and the second rib are configured to contact an outer surface of the first rod member.

7. A bed frame, comprising:
a bed slat frame, wherein the bed slat frame comprises a first rod member and a second rod member, and an accommodating groove is formed in a side of the first rod member; and
a connector, wherein the connector is accommodated in the accommodating groove, and the second rod member is connected to the first rod member through the connector; and the connector comprises an insertion body and a buffer body, wherein an insertion groove is formed in the insertion body, and the insertion groove matches an end portion of the second rod member and is configured to receive the second rod member; and the buffer body is disposed at a lower end of the insertion body and configured to buffer a pressure applied by the second rod member to the insertion body.

8. The bed frame according to claim 7, wherein the bed frame further comprises a support leg, wherein the support leg is connected to the bed slat frame and configured to support the bed slat frame, a plurality of first screw holes are formed in the support leg along a height direction thereof, a second screw hole is formed in a side portion of the bed slat frame, and the second screw hole is threadedly connected to one of the first screw holes through a screw.

9. The bed frame according to claim 7, wherein the bed slat frame further comprises a U-shaped connecting bracket, the first rod member comprises a first side rod and a second side rod, the U-shaped connecting bracket comprises two opposite ends, and the two ends of the U-shaped connecting bracket are hinged to the first side rod and the second side rod, respectively, and configured to drive the first side rod to rotate relative to the second side rod.

10. The bed frame according to claim 7, wherein the bed slat frame comprises a baffle plate, wherein the baffle plate is mounted on the first rod member.
